(19) United States
(12) Patent Application Publication
(10) Pub. No.: US 2019/0391384 A1
(43) Pub. Date: Dec. 26, 2019

(54) HEADWEAR WITH BUILT-IN MAGNIFIER

(71) Applicant: Valerie Rushmere, Philadelphia, PA (US)

(72) Inventor: Valerie Rushmere, Philadelphia, PA (US)

(21) Appl. No.: 16/015,084

(22) Filed: Jun. 21, 2018

(51) Int. Cl. G02B 25/00; A45D 8/36; A42B 1/24

(52) U.S. Cl. CPC G02B 25/002; A45D 8/36; G02C 3/02; G02B 25/004; A42B 1/247

(57) ABSTRACT

A headwear item such as a headband or hat includes a built-in or integral magnifier such as one or more a magnifying lenses or magnifying glasses. The headwear item with the built-in magnifier provides a convenient way for people to carry a magnifier on their person such that they will be less likely to leave the magnifier behind.

### BACKGROUND OF THE INVENTION

### 1. Field of the Invention

The present invention relates to headwear having a built-in magnifier.

### 2. Description of the Prior Art

It is common for older adults, typically those in the age range of 38 to 50 years, to begin to develop age-related farsightedness or presbyopia. This condition results in the person having difficulty focusing on near objects such as printed words in a book, newspaper, or product label or the words displayed on a computer or mobile device screen. The common solution to this problem is the use of “reading glasses.” However, it is inconvenient to carry for a person to carry glasses around with them at all times, which they only need to use occasionally. Therefore, it is often the case that people forget to carry their reading glasses on their person at all times and do not have their glasses available to them when they need their glasses such as when they need to read a product label or a price tag in a store. The need persists for a convenient way for people to carry a magnifier on their person such that they will be less likely to leave the magnifier behind.

### SUMMARY OF THE INVENTION

The present invention is directed to a headwear accessory such as a headband or hat that has a built-in or integral magnifier such as one or more magnifying lenses or magnifying glasses.

Accordingly, it is an aspect of the present invention to provide a magnifier device comprising:
a headwear item that is normally worn for a purpose other than supporting a magnifier; and
a magnifier supported by the headwear item.

It is another aspect of the present invention to provide a magnifier device in accordance with any of the other relevant aspects of the present invention as set forth herein, wherein the purpose for which the headwear item is normally worn is selected from the group consisting of fashion accessory, keeping the wearer's hair under control, protecting the wearer from the sun, protecting the wearer from elements other than the sun, and combinations of these.

It is yet another aspect of the present invention to provide a magnifier device in accordance with any of the other relevant aspects of the present invention as set forth herein, wherein the headwear item is selected from the group consisting of headbands and hats.

It is yet another aspect of the present invention to provide a magnifier device in accordance with any of the other relevant aspects of the present invention as set forth herein, wherein the headwear item is selected from the group consisting of headbands and hats.

It is yet another aspect of the present invention to provide a magnifier device in accordance with any of the other relevant aspects of the present invention as set forth herein, wherein the headwear item is a headband.

It is yet another aspect of the present invention to provide a magnifier device in accordance with any of the other relevant aspects of the present invention as set forth herein, wherein the headband has a middle portion that extends over the top of the wearer's head, in a direction transverse to the sagittal plane of the wearer's head, when worn as a headband is normally worn, and
wherein the headband has left and right lateral portions that extend downward on either side of the middle portion and engage the left and right sides of the wearer's head, respectively, at locations within the portions of the wearer's head surrounding the ears, that include the temporal regions, the temporomandibular regions and portions of the parietal and occipital regions proximate the temporal regions, in order to hold the headband on the wearer's head when the headband is being worn as a headband is normally worn.

It is yet another aspect of the present invention to provide a magnifier device in accordance with any of the other relevant aspects of the present invention as set forth herein, wherein the headband is approximately horseshoe-shaped and is made of a flexible and resilient material such that the internal resilience of the headband provides sufficient force for pressing left and right lateral portions of the headband against the left and right sides of the wearer's head in order to hold the headband on the wearer's head when the headband is being worn as a headband is normally worn under normal conditions.

It is yet another aspect of the present invention to provide a magnifier device in accordance with any of the other relevant aspects of the present invention as set forth herein, wherein the middle portion of the headband is curved to approximately follow the curvature of the top of the wearer's head in the direction transverse to the sagittal plane of the wearer's head.

It is yet another aspect of the present invention to provide a magnifier device in accordance with any of the other relevant aspects of the present invention as set forth herein, wherein the magnifier comprises one or more magnifying lenses.

It is yet another aspect of the present invention to provide a magnifier device in accordance with any of the other relevant aspects of the present invention as set forth herein, wherein each of the one or more magnifying lenses is transparent.

It is yet another aspect of the present invention to provide a magnifier device in accordance with any of the other relevant aspects of the present invention as set forth herein, wherein the headband is provided with one or more openings at least in the middle portion of the headband and wherein each of the one or more magnifying lenses is received in a corresponding one of the one or more openings such that portions of the headband surrounding the corresponding one of the one or more openings forms a frame for a corresponding one of the one or more magnifying lenses received within the corresponding one of the one or more openings.

It is yet another aspect of the present invention to provide a magnifier device in accordance with any of the other relevant aspects of the present invention as set forth herein, wherein the magnifier comprises at least two magnifying lenses and wherein the headband has at least two openings for receiving the lenses such that there is one magnifying lens for each eye of the wearer.

It is yet another aspect of the present invention to provide a magnifier device in accordance with any of the other relevant aspects of the present invention as set forth herein, wherein the headband has an underside that faces toward the wearer's head when the headband is being worn as a headband is normally worn, and wherein the headband may further comprise a plurality of teeth, tines, or prongs projecting from the underside for engaging the wearer's hair and with at least some of the wearer's hair being received between the plurality of teeth, tines, or prongs when the headband is being worn as a headband is normally worn.

It is yet another aspect of the present invention to provide a magnifier device in accordance with any of the other relevant aspects of the present invention as set forth herein, wherein the headband further comprises a plurality of teeth, tines, or prongs for engaging the wearer's hair and with at least some of the wearer's hair being received between the plurality of teeth, tines, or prongs when the headband is being worn as a headband is normally worn.

It is yet another aspect of the present invention to provide a magnifier device in accordance with any of the other relevant aspects of the present invention as set forth herein, wherein the headband may be provided with one or more notches to accommodate the bridge of the wearer's or other person's nose when the magnifier device is being used for magnifying an object being viewed.

It is yet another aspect of the present invention to provide a magnifier device in accordance with any of the other relevant aspects of the present invention as set forth herein, wherein the headband is provided with two notches on opposite sides of the headband to accommodate the bridge of the wearer's or other person's nose when the magnifier device is being used for viewing an object regardless of which side of the headband is proximate the nose of the wearer or person viewing the object.

It is yet another aspect of the present invention to provide a magnifier device in accordance with any of the other relevant aspects of the present invention as set forth herein, wherein the magnifier comprises one elongated magnifying lens and wherein the headband has an elongated opening for receiving the elongated magnifying lens such that the magnifying lens is long enough to allow viewing with both eyes.

It is yet another aspect of the present invention to provide a magnifier device in accordance with any of the other relevant aspects of the present invention as set forth herein, wherein the elongated lens and the elongated opening are elongated along a direction transverse to the sagittal plane of the wearer's head, wherein the middle portion of the headband has a curvature that approximately follows the curvature of the top of the wearer's head in the direction transverse to the sagittal plane of the wearer's head, and wherein the elongated lens follows the curvature of the middle portion of the headband.

It is yet another aspect of the present invention to provide a magnifier device in accordance with any of the other relevant aspects of the present invention as set forth herein, wherein the headwear item is a hat having a head covering portion and a bill or brim, wherein the magnifier comprises one or more magnifying lenses, and wherein the magnifier device further comprises a frame hingedly attached to the bill or brim that supports the one or more magnifying lenses.

It is yet another aspect of the present invention to provide a magnifier device in accordance with any of the other relevant aspects of the present invention as set forth herein, wherein the magnifier comprises two magnifying lenses, wherein the frame has at least two openings for receiving the lenses such that there is one magnifying lens for each eye of the wearer, and wherein each of the magnifying lenses is received in a corresponding one of the openings such that portions of the frame surrounding the corresponding one of the openings frames a corresponding one of the magnifying lenses received within the corresponding one of the openings.

It is yet another aspect of the present invention to provide a magnifier device in accordance with any of the other relevant aspects of the present invention as set forth herein, wherein the frame is hingedly attached to the bill or brim by hinges located proximate to where the bill or brim attaches to the head covering portion of the hat such that the frame pivots away from the wearer's face when being moved to a stowed position in which the frame lies flat against the underside of the bill or brim and such that the frame and lenses are at the proper distance from the wearer's eyes for providing proper focus when the frame is in the deployed position in front of the wearer's eyes.

It is yet another aspect of the present invention to provide a magnifier device in accordance with any of the other relevant aspects of the present invention as set forth herein, wherein the frame is provided with a notch to accommodate the bridge of the wearer's nose when the frame and magnifying lenses are being used for viewing an object.

It is yet another aspect of the present invention to provide a magnifier device in accordance with any of the other relevant aspects of the present invention as set forth herein, wherein the frame is provided with a notch located between the lenses to accommodate the bridge of the wearer's nose when the frame and magnifying lenses are being used for viewing an object.

These and other aspects and advantages of the present invention will be further elucidated by the following Detailed Description, drawing figures, and Claims.

### BRIEF DESCRIPTION OF THE DRAWING FIGURES

FIGS. 1-4 show a first embodiment of the headwear having a built-in magnifier according to the present invention.

FIGS. 5-8 show a second embodiment of the headwear having a built-in magnifier according to the present invention.

FIGS. 9-12 show a third embodiment of the headwear having a built-in magnifier according to the present invention.

### DETAILED DESCRIPTION

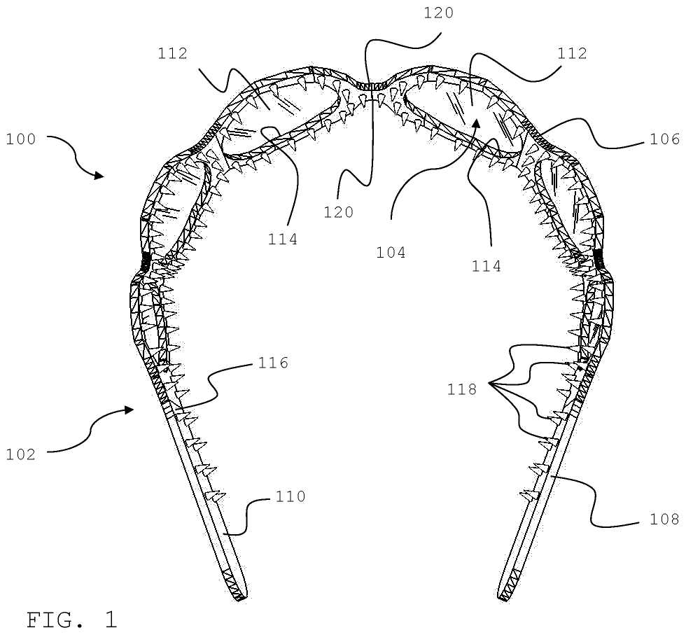

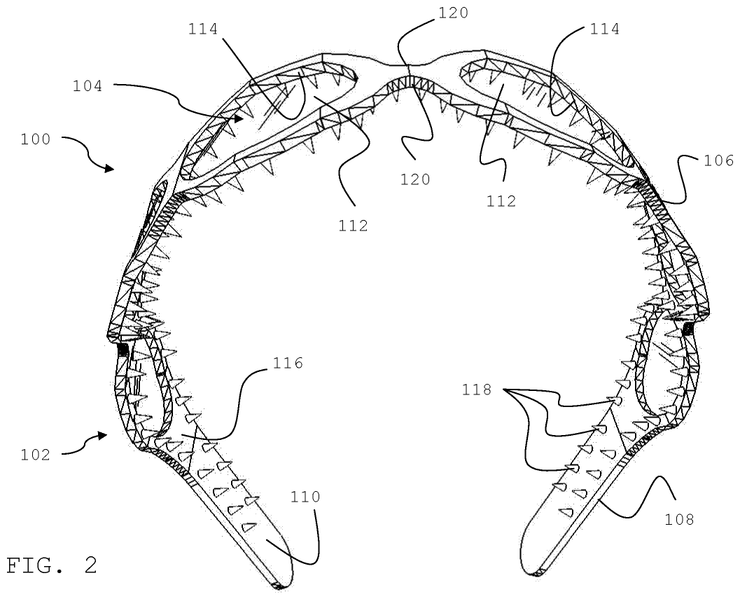

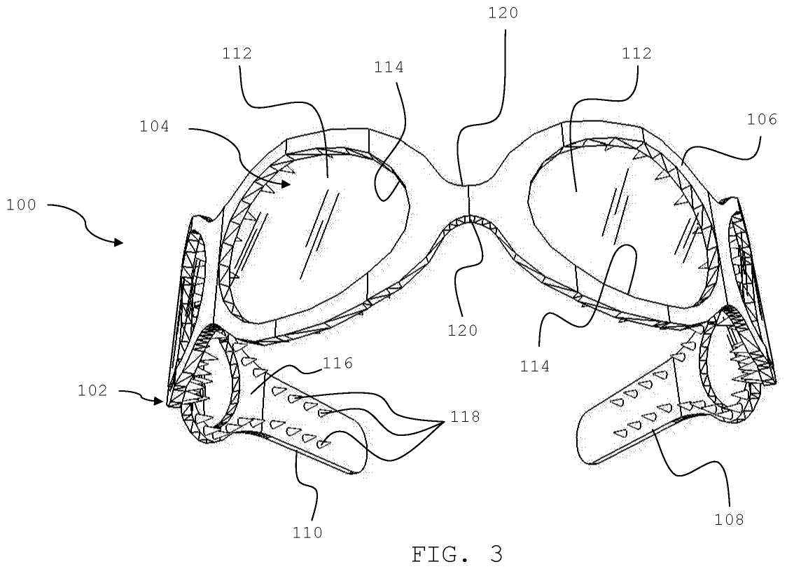

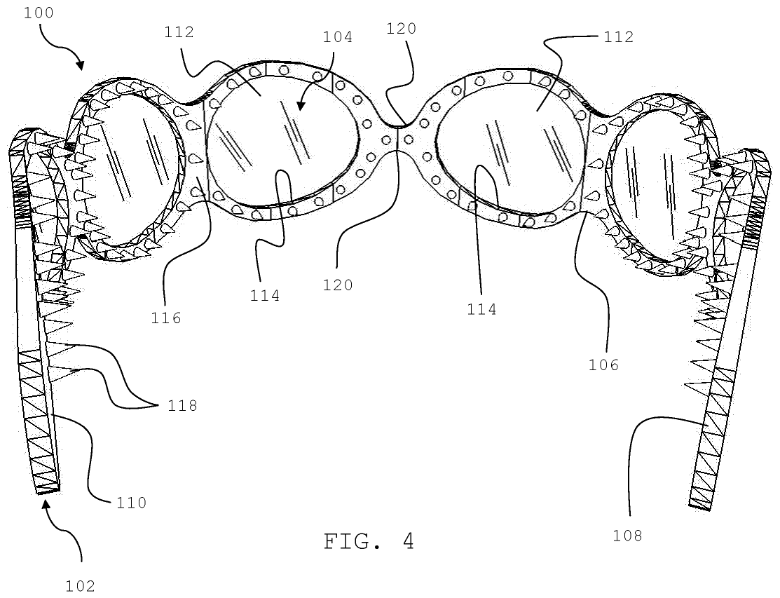

Referring to FIGS. 1-4, a first illustrative embodiment of a headwear having a built-in magnifier 100, referred to herein also as a magnifier device 100 in the interest of brevity, can be seen. The magnifier device 100 includes a headwear item 102 and a magnifier 104. The headwear item 102 is normally worn for a purpose other than supporting the magnifier 104. The magnifier 104 is supported by the headwear item 102.

The purpose for which the headwear item 102 is normally worn is selected from the group consisting of fashion accessory, keeping the wearer's hair under control, protecting the wearer from the sun, protecting the wearer from elements other than the sun, and combinations of these. The headwear item 102 is selected from the group consisting of headbands and hats. In the embodiment illustrated in FIGS. 1-4, the headwear item 102 is a headband 102 of the type also known as a hairband or an Alice band.

The headband 102 has a middle portion 106 that extends over the top of the wearer's head, in a direction transverse to the sagittal plane of the wearer's head, when worn as a headband is normally worn. The headband 102 has left and right lateral portions 108 and 110 that extend downward on either side of the middle portion 106 and engage the left and right sides of the wearer's head, respectively, in order to hold the headband on the wearer's head when the headband is being worn as a headband is normally worn. The left and right lateral portions 108 and 110 engage the left and right sides of the wearer's head at locations within the portions of the wearer's head surrounding the ears that include the temporal regions, the temporomandibular regions, and portions of the parietal and occipital regions proximate the temporal regions.

The headband 102 is approximately horseshoe-shaped and is made of a flexible and resilient material such that the internal resilience of the headband provides sufficient force for pressing left and right lateral portions 108 and 110 of the headband against the left and right sides of the wearer's head in order to hold the headband 102 on the wearer's head when the headband 102 is being worn as a headband is normally worn under normal conditions. The middle portion of the headband 102 is curved to approximately follow the curvature of the top of the wearer's head in the direction transverse to the sagittal plane of the wearer's head.

In the embodiment illustrated in FIGS. 1-4, the magnifier 104 comprises one or more magnifying lenses 112. Each of the one or more magnifying lenses 112 is transparent to allow viewing of objects.

The headband 102 is provided with one or more openings 114 at least in the middle portion of the headband 102. Each of the one or more magnifying lenses 112 is received in a corresponding one of the one or more openings 114 such that portions of the headband surrounding the corresponding one of the one or more openings 114 form a frame for a corresponding one of the one or more magnifying lenses 112 received within the corresponding one of the one or more openings 114.

In the embodiment illustrated in FIGS. 1-4, the magnifier 104 comprises at least two magnifying lenses 112 and wherein the headband 102 has at least two openings 114 for receiving the lenses 112 such that there is one magnifying lens 112 for each eye of the wearer. In the embodiment illustrated in FIGS. 1-4, the headband 102 has an underside 116 that faces toward the wearer's head when the headband is being worn as a headband is normally worn. The headband 102 also includes a plurality of teeth, tines, or prongs 118 projecting from the underside 116 for engaging the wearer's hair, with at least some of the wearer's hair being received between the plurality of teeth, tines, or prongs 118, when the headband 102 is being worn as a headband is normally worn. In some alternative embodiments, the plurality of teeth, tines, or prongs may project out from parts of the headband other than the underside.

The headband 102 is preferably provided with one or more notches 120 to accommodate the bridge of the wearer's or other person's nose when the magnifier device 100 is being used for magnifying an object being viewed. In the embodiment illustrated in FIGS. 1-4, the headband 102 is provided with two notches 120 on opposite sides of the headband 102 to accommodate the bridge of the wearer's or other person's nose when the magnifier device 100 is being used for viewing an object regardless of which side of the headband 102 is proximate the nose of the wearer or person viewing the object.

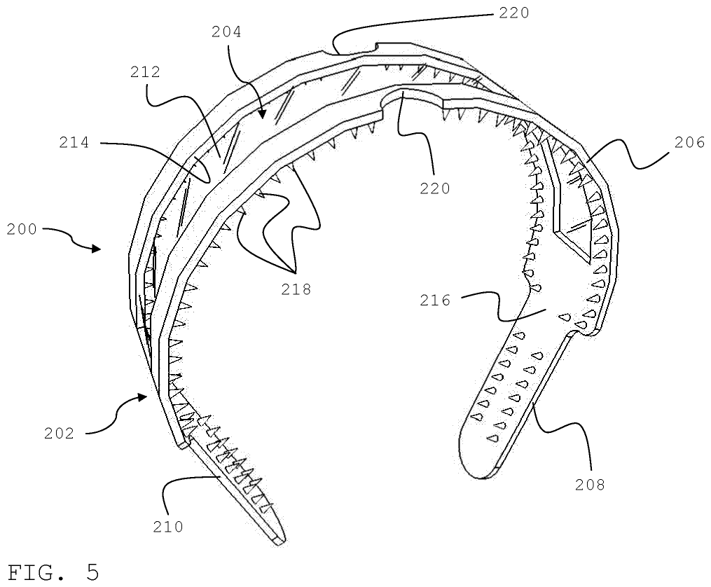

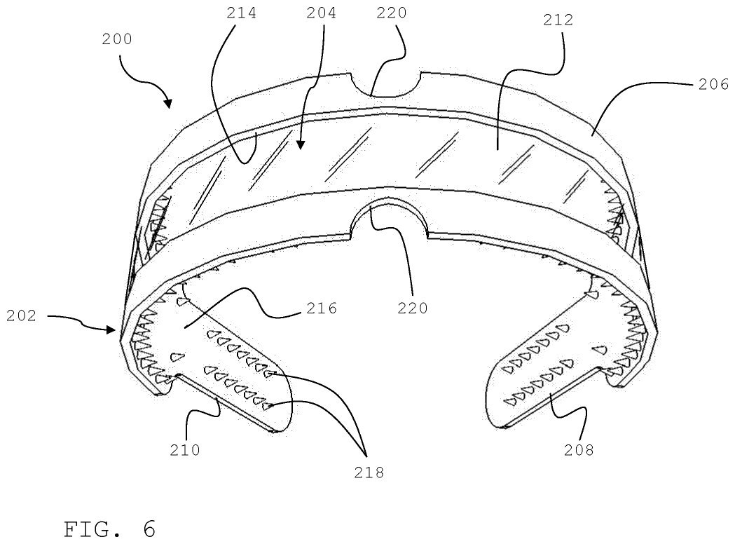

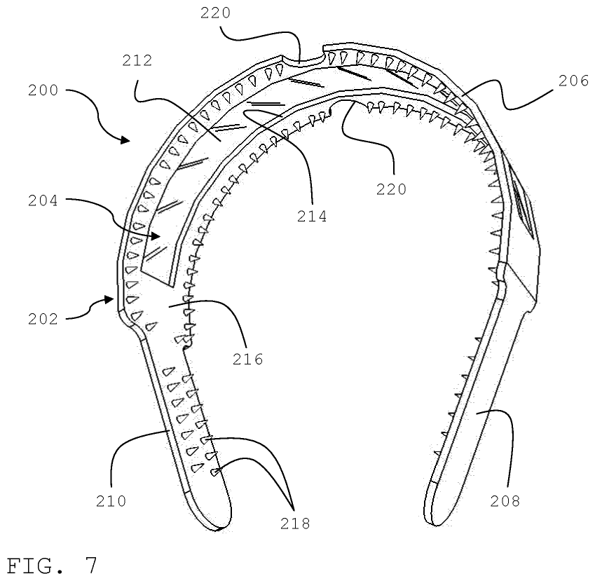

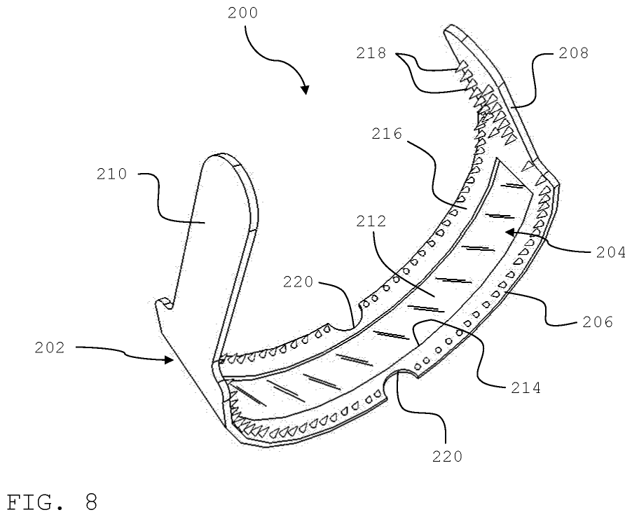

Referring to FIGS. 5-8, a second illustrative embodiment of a headwear having a built-in magnifier 200, referred to herein also as a magnifier device 200 in the interest of brevity, can be seen. The magnifier device 200 includes a headwear item 202 and a magnifier 204. In the embodiment illustrated in FIGS. 5-8, the headwear item 202 is a headband 202 of the type also known as a hairband or an Alice band.

The headband 202 has a middle portion 206 that extends over the top of the wearer's head, in a direction transverse to the sagittal plane of the wearer's head, when worn as a headband is normally worn. The headband 202 has left and right lateral portions 208 and 210 that extend downward on either side of the middle portion 206 and engage the left and right sides of the wearer's head, respectively, in order to hold the headband on the wearer's head when the headband is being worn as a headband is normally worn. The left and right lateral portions 208 and 210 engage the left and right sides of the wearer's head at locations within the portions of the wearer's head surrounding the ears that include the temporal regions, the temporomandibular regions, and portions of the parietal and occipital regions proximate the temporal regions.

The headband 202 is approximately horseshoe-shaped and is made of a flexible and resilient material such that the internal resilience of the headband provides sufficient force for pressing left and right lateral portions 208 and 210 of the headband against the left and right sides of the wearer's head in order to hold the headband 202 on the wearer's head when the headband 202 is being worn as a headband is normally worn under normal conditions. The middle portion of the headband 202 is curved to approximately follow the curvature of the top of the wearer's head in the direction transverse to the sagittal plane of the wearer's head.

In the embodiment illustrated in FIGS. 5-8, the magnifier 204 comprises one elongated magnifying lens 212. The headband 202 has an elongated opening 214 for receiving the elongated magnifying lens 212 such that the magnifying lens 212 is long enough to allow viewing with both eyes. The elongated lens 212 and the elongated opening 214 are elongated along a direction transverse to the sagittal plane of the wearer's head. As with the first embodiment, the middle portion 206 of the headband 202 has a curvature that approximately follows the curvature of the top of the wearer's head in the direction transverse to the sagittal plane of the wearer's head. The elongated lens 212 follows the curvature of the middle portion of the headband 202. The magnifying portions of the lens 212 may be cut within the thickness of the lens 212 so as to present a magnifying lens that is properly positioned relative to the wearer's eye to avoid distortion due to the curvature of the lens 212. The same applies to the first embodiment 100. The magnifying lens 112 is transparent to allow viewing of objects. The magnifying lens 212 is received in the opening 214 such that portions of the headband 202 surrounding the opening 214 form a frame for the magnifying lens 212 received within the opening 214.

The headband 202 also includes a plurality of teeth, tines, or prongs 218 projecting from the underside 216 for engaging the wearer's hair, with at least some of the wearer's hair being received between the plurality of teeth, tines, or prongs 218, when the headband 202 is being worn as a headband is normally worn. In some alternative embodiments, the plurality of teeth, tines, or prongs may project out from parts of the headband other than the underside.

The headband 202 is preferably provided with one or more notches 220 to accommodate the bridge of the wearer's or other person's nose when the magnifier device 200 is being used for magnifying an object being viewed. In the embodiment illustrated in FIGS. 5-8, the headband 202 is provided with two notches 220 on opposite sides of the headband 202 to accommodate the bridge of the wearer's or other person's nose when the magnifier device 200 is being used for viewing an object regardless of which side of the headband 202 is proximate the nose of the wearer or person viewing the object.

The headbands 102 and 202 are preferably made of plastic or other suitable polymer material with the required resilience and flexibility.

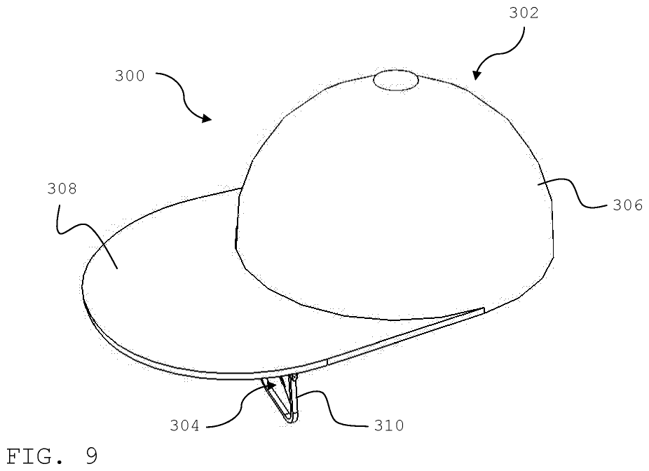

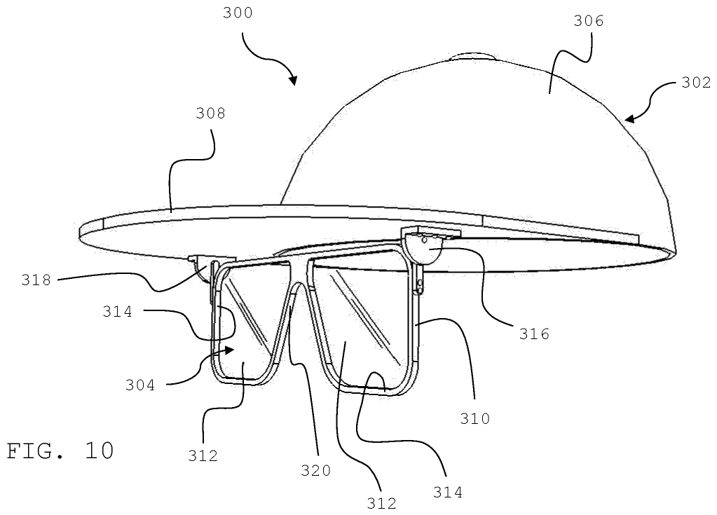

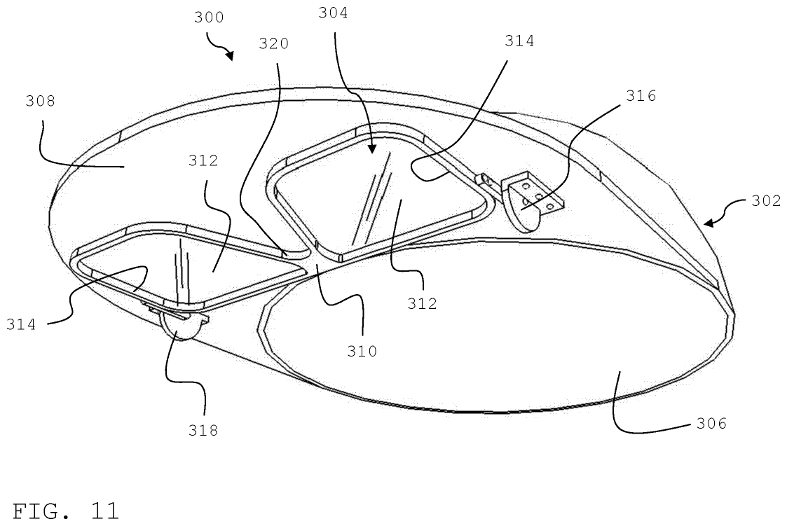

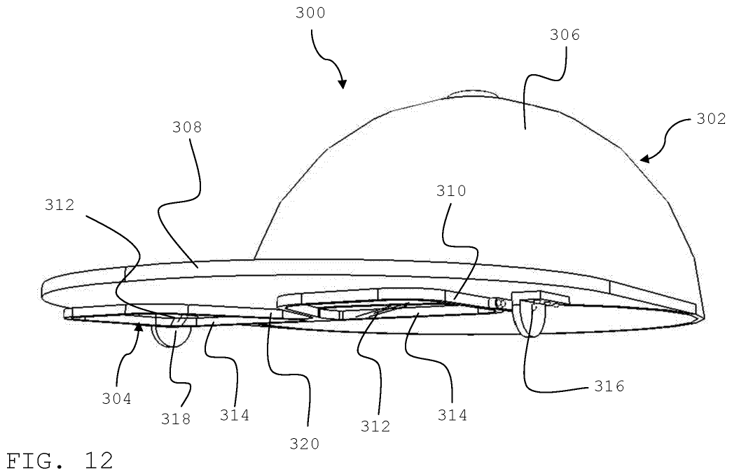

Referring to FIGS. 9-12, a third embodiment 300 of the magnifier device according to the present invention can be seen. The magnifier device includes a headwear item 302 and a magnifier 304. The headwear item 302 is a hat 302 having a head covering portion 306 and a bill or brim 308. The magnifier 304 comprises one or more magnifying lenses 312. The magnifier device 300 further includes a frame 310 that is hingedly attached to the bill or brim 308 and that supports the one or more magnifying lenses 312.

In the embodiment illustrated in FIGS. 9-12, the magnifier 304 comprises two magnifying lenses 312. The frame 310 has at least two openings 314 for receiving the lenses 312 such that there is one magnifying lens for each eye of the wearer. Each of the magnifying lenses 312 is received in a corresponding one of the openings 314 such that portions of the frame 310 surrounding the corresponding one of the openings 314 frames a corresponding one of the magnifying lenses 312 received within the corresponding one of the openings 314.

The frame 310 is hingedly attached to the bill or brim 308 by hinges 316 and 318 located proximate to where the bill or brim 308 attaches to the head covering portion 306 of the hat 302 such that the frame pivots away from the wearer's face when being moved to a stowed position in which the frame lies flat against the underside of the bill or brim 308 and such that the frame 310 and lenses 312 are at the proper distance from the wearer's eyes for providing proper focus when the frame 310 is in the deployed position in front of the wearer's eyes.

The frame 310 is provided with a notch 320 located between the lenses 312 to accommodate the bridge of the wearer's nose when the frame 310 and magnifying lenses 312 are being used for viewing an object, i.e. are in the deployed position.

It should be understood that the present invention is not limited to the specific embodiments described above, but includes any and all variations or modifications within the spirit and scope of the present invention as defined in the appended claims.

1. A magnifier device comprising:
a headwear item that is normally worn for a purpose other than supporting a magnifier; and
a magnifier supported by said headwear item.

2. The magnifier device of claim 1, wherein said purpose for which said headwear item is normally worn is selected from the group consisting of fashion accessory, keeping the wearer's hair under control, protecting the wearer from the sun, protecting the wearer from elements other than the sun, and combinations of these.

3. The magnifier device of claim 2, wherein said headwear item is selected from the group consisting of headbands and hats.

4. The magnifier device of claim 1, wherein said headwear item is selected from the group consisting of headbands and hats.

5. The magnifier device of claim 4, wherein said headwear item is a headband.

6. The magnifier device of claim 5, wherein said headband has a middle portion that extends over the top of the wearer's head, in a direction transverse to the sagittal plane of the wearer's head, when worn as a headband is normally worn, and
wherein said headband has left and right lateral portions that extend downward on either side of said middle portion and engage the left and right sides of the wearer's head, respectively, at locations within the portions of the wearer's head surrounding the ears, that include the temporal regions, the temporomandibular regions and portions of the parietal and occipital regions proximate the temporal regions, in order to hold the headband on the wearer's head when said headband is being worn as a headband is normally worn.

7. The magnifier device of claim 6, wherein said headband is approximately horseshoe-shaped and is made of a flexible and resilient material such that the internal resilience of the headband provides sufficient force for pressing left and right lateral portions of said headband against the left and right sides of the wearer's head in order to hold the headband on the wearer's head when said headband is being worn as a headband is normally worn under normal conditions.

8. The magnifier device of claim 6, wherein said middle portion of said headband is curved to approximately follow the curvature of the top of the wearer's head in the direction transverse to the sagittal plane of the wearer's head.

9. The magnifier device of claim 6, wherein said magnifier comprises one or more magnifying lenses.

10. The magnifier device of claim 9, wherein each of said one or more magnifying lenses is transparent.

11. The magnifier device of claim 9, wherein said headband is provided with one or more openings at least in said middle portion of said headband and wherein each of said one or more magnifying lenses is received in a corresponding one of said one or more openings such that portions of the headband surrounding said corresponding one of said one or more openings forms a frame for a corresponding one of said one or more magnifying lenses received within said corresponding one of said one or more openings.

12. The magnifier device of claim 11, wherein said magnifier comprises at least two magnifying lenses and wherein said headband has at least two openings for receiving said lenses such that there is one magnifying lens for each eye of the wearer.

13. The magnifier device of claim 11, wherein said headband has an underside that faces toward the wearer's head when said headband is being worn as a headband is normally worn, and wherein said headband further comprises a plurality of teeth, tines, or prongs projecting from said underside for engaging the wearer's hair and with at least some of the wearer's hair being received between said plurality of teeth, tines, or prongs when said headband is being worn as a headband is normally worn.

14. The magnifier device of claim 11, wherein said headband further comprises a plurality of teeth, tines, or prongs for engaging the wearer's hair and with at least some of the wearer's hair being received between said plurality of teeth, tines, or prongs when said headband is being worn as a headband is normally worn.

15. The magnifier device of claim 11, wherein said headband is provided with one or more notches to accommodate the bridge of the wearer's or other person's nose when the magnifier device is being used for magnifying an object being viewed.

16. The magnifier device of claim 11, wherein said headband is provided with two notches on opposite sides of said headband to accommodate the bridge of the wearer's or other person's nose when the magnifier device is being used for viewing an object regardless of which side of the headband is proximate the nose of the wearer or person viewing the object.

17. The magnifier device of claim 11, wherein said magnifier comprises one elongated magnifying lens and wherein said headband has an elongated opening for receiving said elongated magnifying lens such that said magnifying lens is long enough to allow viewing with both eyes.

18. The magnifier device of claim 17, wherein said elongated lens and said elongated opening are elongated along a direction transverse to the sagittal plane of the wearer's head, wherein said middle portion of said headband has a curvature that approximately follows the curvature of the top of the wearer's head in the direction transverse to the sagittal plane of the wearer's head, and wherein said elongated lens follows said curvature of said middle portion of said headband.

19. The magnifier device of claim 4, wherein said headwear item is a hat having a head covering portion and a bill or brim, wherein said magnifier comprises one or more magnifying lenses, and wherein said magnifier device further comprises a frame hingedly attached to said bill or brim that supports said one or more magnifying lenses.

20. The magnifier device of claim 19, wherein said magnifier comprises two magnifying lenses, wherein said frame has at least two openings for receiving said lenses such that there is one magnifying lens for each eye of the wearer, and wherein each of said magnifying lenses is received in a corresponding one of said openings such that portions of the frame surrounding said corresponding one of said openings frames a corresponding one of said magnifying lenses received within said corresponding one of said openings.

21. The magnifier device of claim 19, wherein said frame is hingedly attached to said bill or brim by hinges located proximate to where said bill or brim attaches to said head covering portion of said hat such that said frame pivots away from the wearer's face when being moved to a stowed position in which the frame lies flat against the underside of said bill or brim and such that the frame and lenses are at the proper distance from the wearer's eyes for providing proper focus when the frame is in the deployed position in front of the wearer's eyes.

22. The magnifier device of claim 19, wherein said frame is provided with a notch to accommodate the bridge of the wearer's nose when the frame and magnifying lenses are being used for viewing an object.

23. The magnifier device of claim 20, wherein said frame is provided with a notch located between said lenses to accommodate the bridge of the wearer's nose when the frame and magnifying lenses are being used for viewing an object.
